(19) United States
(12) Patent Application Publication
(10) Pub. No.: US 2020/0232431 A1
(43) Pub. Date: Jul. 23, 2020

(54) METHOD OF MANAGING HEAT OF INJECTOR BACKFLOW

(71) Applicant: PRATT & WHITNEY CANADA CORP., Longueuil (CA)

(72) Inventors: Etienne PLAMONDON, Candiac (CA); Sebastien BERGERON, Chambly (CA); Benjamin RENAUD, Montreal (CA); Jean-Gabriel GAUVREAU, Varennes (CA)

(21) Appl. No.: 16/251,512

(22) Filed: Jan. 18, 2019

(51) Int. Cl. F02M 53/04; F01P 3/16; F02B 53/10

(52) U.S. Cl. CPC F02M 53/043; F02B 53/10; F01P 3/16

(57) ABSTRACT

There is disclosed a method of operating an engine assembly including an internal combustion engine, a common-rail injector for injecting fuel in a combustion chamber of the internal combustion engine, and an oil circuit for lubricating components of the engine assembly. The method includes: injecting fuel in the combustion chamber via the common-rail injector; and exchanging heat between a backflow of fuel from the common-rail injector with oil of an oil circuit of the engine assembly.

### TECHNICAL FIELD

The application relates generally to internal combustion engines and, more particularly, to heat management of such engines.

### BACKGROUND OF THE ART

Internal combustion engines include at least one combustion chamber. An injector is configured to inject fuel in the combustion chamber. Some injectors, such as common-rail injectors, generate a backflow of fuel that can reach high temperature during engine operation. More specifically, the heat comes from the expansion from high pressure to low pressure. The fuel has to be highly pressurized first before expanded. This heat is typically wasted or directly return to the fuel tank. Better and more efficient heat management is desirable.

### SUMMARY

In one aspect, there is provided a method of operating an engine assembly including an internal combustion engine, a common-rail injector for injecting fuel in a combustion chamber of the internal combustion engine, and an oil circuit for lubricating components of the engine assembly, the method comprising: injecting fuel in the combustion chamber via the common-rail injector; and exchanging heat between a backflow of fuel from the common-rail injector with oil of an oil circuit of the engine assembly.

In another aspect, there is provided a method of operating an engine assembly including an internal combustion engine, a common-rail injector for injecting fuel in a combustion chamber of the internal combustion engine, and an oil circuit for lubricating components of the engine assembly, the method comprising: determining that the engine assembly is in an engine warm-up phase; and operating the engine assembly in an engine warm-up mode in which a backflow of fuel from the common-rail injector is in heat exchange relationship with oil of the oil circuit of the engine assembly.

In yet another aspect, there is provided an engine assembly, comprising: an internal combustion engine having at least one combustion chamber; at least one injector having an inlet fluidly connected to a source of fuel, a first outlet fluidly connected to the at least one combustion chamber, and a second outlet; an oil circuit configured for circulating oil through components of the engine assembly; and a heat exchanger having at least one first conduit and at least one second conduit in heat exchange relationship with the at least one first conduit, the second outlet of the at least one injector fluidly connected to the at least one first conduit, the oil circuit in fluid flow communication with the at least one second conduit of the heat exchanger.

### DESCRIPTION OF THE DRAWINGS

Reference is now made to the accompanying figures in which:

FIG. 1 is a schematic cross-sectional view of a rotary internal combustion engine in accordance with a particular embodiment;

FIG. 2 is a schematic view of an engine assembly in accordance with one embodiment; and

FIG. 3 is a schematic view of a portion of the engine assembly of FIG. 2.

### DETAILED DESCRIPTION

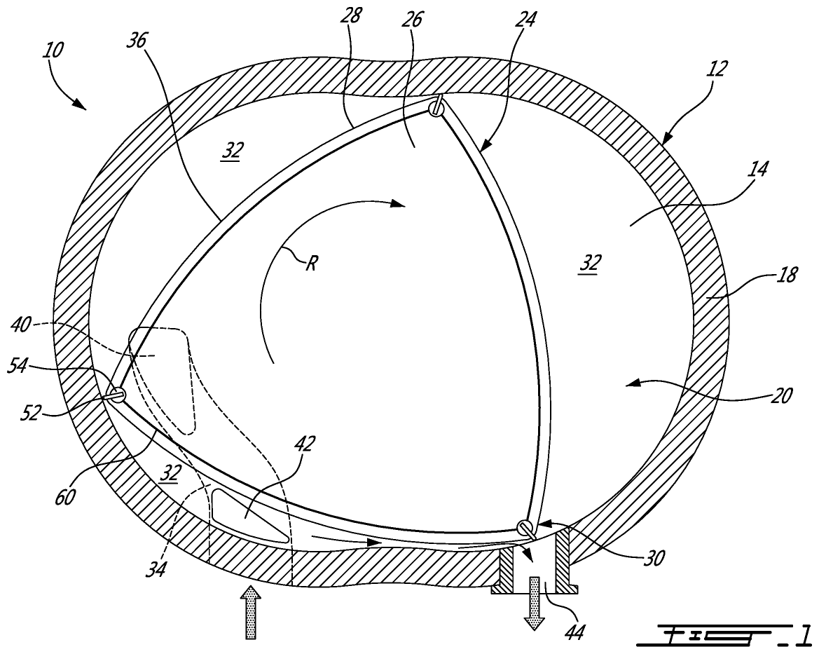

Referring to FIG. 1, a rotary internal combustion engine 10 known as a Wankel engine is schematically shown. The rotary engine 10 comprises an outer body 12 having axially-spaced end walls 14 with a peripheral wall 18 extending therebetween to form a rotor cavity 20. The inner surface of the peripheral wall 18 of the cavity 20 has a profile defining two lobes, which is preferably an epitrochoid.

An inner body or rotor 24 is received within the cavity 20. The rotor 24 has axially spaced end faces 26 adjacent to the outer body end walls 14, and a peripheral face 28 extending therebetween. The peripheral face 28 defines three circumferentially-spaced apex portions 30, and a generally triangular profile with outwardly arched sides 36. The apex portions 30 are in sealing engagement with the inner surface of peripheral wall 18 to form three rotating combustion chambers 32 between the inner rotor 24 and outer body 12. The geometrical axis of the rotor 24 is offset from and parallel to the axis of the outer body 12.

The combustion chambers 32 are sealed. In the embodiment shown, each rotor apex portion 30 has an apex seal 52 extending from one end face 26 to the other and biased radially outwardly against the peripheral wall 18. An end seal 54 engages each end of each apex seal 52 and is biased against the respective end wall 14. Each end face 26 of the rotor 24 has at least one arc-shaped face seal 60 running from each apex portion 30 to each adjacent apex portion 30, adjacent to but inwardly of the rotor periphery throughout its length, in sealing engagement with the end seal 54 adjacent each end thereof and biased into sealing engagement with the adjacent end wall 14. Alternate sealing arrangements are also possible.

Although not shown in the Figures, the rotor 24 is journaled on an eccentric portion of a shaft such that the shaft rotates the rotor 24 to perform orbital revolutions within the stator cavity 20. The shaft rotates three times for each complete rotation of the rotor 24 as it moves around the stator cavity 20. Oil seals are provided around the eccentric to impede leakage flow of lubricating oil radially outwardly thereof between the respective rotor end face 26 and outer body end wall 14. During each rotation of the rotor 24, each chamber 32 varies in volumes and moves around the stator cavity 20 to undergo the four phases of intake, compression, expansion and exhaust, these phases being similar to the strokes in a reciprocating-type internal combustion engine having a four-stroke cycle.

The engine includes a primary inlet port 40 in communication with a source of air, an exhaust port 44, and an optional purge port 42 also in communication with the source of air (e.g. a compressor) and located between the inlet and exhaust ports 40, 44. The ports 40, 42, 44 may be defined in the end wall 14 of in the peripheral wall 18. In the embodiment shown, the inlet port 40 and purge port 42 are defined in the end wall 14 and communicate with a same intake duct 34 defined as a channel in the end wall 14, and the exhaust port 44 is defined through the peripheral wall 18. Alternate configurations are possible.

In a particular embodiment, fuel such as kerosene (jet fuel) or other suitable fuel is delivered into the chamber 32 through a fuel port (not shown) such that the chamber 32 is stratified with a rich fuel-air mixture near the ignition source and a leaner mixture elsewhere, and the fuel-air mixture may be ignited within the housing using any suitable ignition system known in the art (e.g. spark plug, glow plug). In a particular embodiment, the rotary engine 10 operates under the principle of the Miller or Atkinson cycle, with its compression ratio lower than its expansion ratio, through appropriate relative location of the primary inlet port 40 and exhaust port 44.

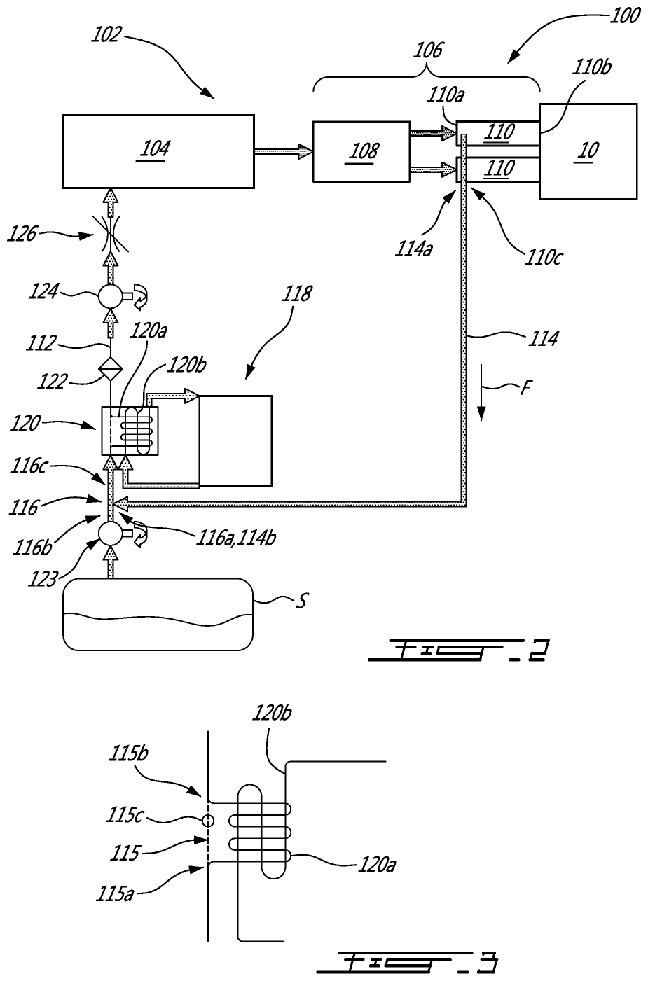

Referring to FIG. 2, an engine assembly is generally shown at 100. The engine assembly 100 may include the internal combustion engine 10 described above with reference to FIG. 1, or any other suitable internal combustion engine.

The engine assembly 100 includes a fuel injection assembly 102 for providing fuel to the internal combustion engine 10 from a source of fuel S, which, in the embodiment shown, comprises a fuel tank. As shown, the fuel injection assembly 102 includes high-pressure pumps 104 and a common-rail injector 106. The common-rail injector 106 includes a common rail 108 and individual injectors 110. The common-rail 108 is in fluid communication with each of the injectors 110.

Each of the fuel injectors 110 includes an inlet 110a, a first outlet 110b, and a second outlet 110c. The inlet 110a is fluidly connected to the source S of fuel, in the embodiment shown via the high-pressure pump(s) 104 and the common rail 108. The first outlet 110b is fluidly connected to the combustion chamber 32 (FIG. 1) of the internal combustion engine 10. The second outlet 110c is configured for expelling a backflow F of fuel from the injector.

In a particular embodiment, the injector 110 includes housings and pistons movable within the housings from a first position in which the piston blocks the first outlet 110b of the injector 110 to a second position in which the piston is distanced from the first outlet 110b for allowing the fuel from the source of fuel S to be injected in the combustion chamber 32. Movement of the piston is induced by a pressure differential created by the high-pressure pumps 104. When the piston moves from the first position to the second position, a portion of the fuel that enters the injector 110 via its inlet 110a is not injected in the combustion chamber 32 and is expelled out of the injector 110 while bypassing the combustion chamber 32. The backflow F corresponds to this portion of the fuel that is expelled via the second outlet 110c of the fuel injector 110.

The temperature of the fuel increases as a result of its passage through the high-pressure pumps 104. In use, the fuel that exits the injector 110 via the second outlet 110c can reach relatively high temperatures during the expansion process from the high pressure common-rail inlet to the low pressure circuit. As will be seen herein below, it is herein proposed to use this source of energy (i.e. to use the heat of the backflow F of fuel).

The fuel injection assembly 102 further has a main conduit 112, for supplying the fuel from the source of fuel S to the injector 110, and a return conduit 114 for receiving the backflow F of fuel.

In the embodiment shown, a connector 116 connects the return conduit 114 to the main conduit 112. More specifically, the connector 116 has a first inlet 116a, a second inlet 116b, and one outlet 116c. The outlet 116c of the connector 116 is fluidly connected to the main conduit 112, which is, in turn, connected to the inlet side of the pump 104 and, thus, to the common rail injector 106. The first inlet 116a of the connector 116 is fluidly connected to the second outlet 110c of the injector 110. The second inlet 116b is fluidly connected to the source of fuel S. As shown, the first inlet 116a is fluidly connected to the second outlet 110c of the injector 110 via the return conduit 114.

The engine assembly 100 further includes an oil circuit 118 configured for circulating oil through component(s) of the engine assembly 100. The oil circuit 118 may, for instance, be used for circulating oil in a gearbox that needs lubrication for proper operation.

Referring to FIGS. 2-3, the engine assembly 100 further includes a heat exchanger 120 having at least one first conduit 120a and at least one second conduit 120b in heat exchange relationship with the at least one first conduit 120a. The heat exchanger 120 may be referred to as a Fuel Oil Heat Exchanger (FOHE) and is usually configured for transferring heat from the oil of the oil circuit 118 to the fuel of the fuel distribution assembly 102.

More specifically, the at least one first conduit 120a of the heat exchanger 120 is in fluid flow communication with the fuel distribution assembly 102 and the at least one second conduit 120b of the heat exchanger 120 is in fluid flow communication with the oil circuit 118. The second outlet 110c of the injector 110 is fluidly connected to the at least one first conduit 120a of the heat exchanger 120 via the return conduit 104 and the connector 116.

In the embodiment shown, the at least one first conduit 120a of the heat exchanger 120 is fluidly connected to the main conduit 112 of the fuel distribution assembly 102. Consequently, the at least one first conduit 120a of the heat exchanger 120 receives a mix of fuel from the source of fuel S and from the backflow F. Alternatively, the at least one first conduit 120a of the heat exchanger may be fluidly connected to the return conduit 114 of the assembly 102 such that the at least one first conduit 120a of the heat exchanger solely receives fuel from the backflow F.

Referring more particularly to FIG. 3, the assembly 100 further includes a bypass conduit 115 having a first end 115a and second end 115b. The first end 115a is fluidly connected to the main conduit 112 upstream of the heat exchanger 120. The second end 115b is fluidly connected to the main conduit 112 downstream of the heat exchanger 120. A bypass valve 115c is located on the bypass conduit 115 between the first and second ends 115a, 115b. The bypass valve 115 is operable between a close configuration in which fluid communication between the first end 115a and the second end 115b is limited or blocked and an open configuration in which the first end 115a is fluidly connected to the second end 115b.

The different components of the fuel injection assembly 102 will now be described below following a direction of a flow of fuel.

The fuel is drawn from the source of fuel S by a first pump 123. Then, the fuel circulates through the connector 116, from its second inlet 116b to its outlet 116c before circulating through the at least one first conduit 120a of the heat exchanger 120. The fuel exits the heat exchanger 120 and circulates through a fuel filter 122 and through a second pump 124 mounted in the main conduit 112. The fuel that exits the second pump 124 circulates through a metering valve 126 configured for regulating a flow of fuel to the injectors 110. It is understood that the metering valve 126, the first pump 123, the second pump 124, and the fuel filter 122 may be located at different positions. In a particular embodiment, only one pump is used. Other configurations of these elements are contemplated without departing from the scope of the present disclosure.

The fuel enters the high-pressure pumps 104 followed by the common-rail injector 106 and the fuel is distributed through the plurality of injectors 110 by the common-rail 108. A pressure differential is thereby created between the inlets 110a and the first outlets 110b of the injectors 110 to cause a portion of the fuel to be injected in the combustion chamber 32 (FIG. 1) of the engine 10. A remainder of the fuel is directed out of the injectors 110 via the second outlets 110c. The remainder of the fuel that exits the injectors 110c via their second outlets 110c is hot and circulates, via the return conduit 114, to the at least one first conduit 120a of the heat exchanger 120 where it exchanges heat with oil of the oil circuit 118 that circulates in the at least one second conduit 120b of the heat exchanger 120.

Through its passage in the high-pressure pumps 104, the fuel follows an expansion process and increases in temperature. Hence, hot fuel is available as soon as the internal combustion engine 10 starts. However, the oil of the oil circuit 118 might be cold rendering the engine 10 less efficient during a warm-up phase than it is during a steady-state phase.

Consequently, circulating the hot fuel of the backflow F through the heat exchanger might allow the hot fuel to transfer at least part of its heat to the oil of the oil circuit 118. In a particular embodiment, the disclosed embodiment reduces a duration of the warm-up phase. This might reduce a quantity of fuel that is burned to reach a minimum oil temperature that allow proper engine functionality.

After the warm-up phase, the bypass valve 115c may be moved from the closed configuration to the open configuration such that the fuel bypasses the at least one first conduit 120a of the heat exchanger 120 to avoid the fuel from heating the oil.

Once the engine thermal steady-state is reached, the FOHE 120 can then be used as a sink for hot fuel energy such that the fuel system can operate below its maximum fuel temperature limit. This has the advantage of possibly preventing the need to have an additional cooler for the fuel, also known as an air cooled fuel cooler, without affecting the cooling need of the oil.

For operating the engine assembly 100, fuel is injected in the combustion chamber 32 via the common-rail injector 106; and heat is exchanged between the backflow F of fuel from the common-rail injector 106 with oil of the oil circuit 118 of the engine assembly 100. In the embodiment shown, injecting the fuel includes directing a portion of the injected fuel in the combustion chamber 32 (FIG. 1) and directing a remainder of the injected fuel out of the injector 110 and bypassing the combustion chamber 32. The backflow of fuel corresponds to the remainder of the injected fuel.

In a particular embodiment, exchanging heat between the remainder of the injected fuel with the oil includes heating the oil by cooling the remainder of the injected fuel. In a particular embodiment, exchanging heat between the remainder of the injected fuel with the oil includes cooling the oil by heating the remainder of the injected fuel.

In the depicted embodiment, exchanging heat between the backflow of fuel and the oil includes circulating the backflow of fuel in the at least one first conduit 120a of the heat exchanger 120 and circulating the oil in the at least one second conduit 120b of the heat exchanger 120. In the embodiment shown, the backflow F of fuel is mixed with the flow of fuel from the source of fuel F before exchanging heat between the backflow of fuel and the oil.

In a particular embodiment, exchanging heat between the backflow F of fuel and the oil is performed during the warm-up phase of the engine assembly 100. The backflow F of fuel may be directed toward the common-rail injector 106 without exchanging heat with the oil after completion of the warm-up phase. In the embodiment shown, directing the backflow toward the common-rail injector 106 without exchanging heat with the oil includes directing the backflow F in the bypass conduit 115 having the first end 115a upstream of the heat exchanger 120 and the second end 115b downstream of the heat exchanger 120.

For operating the engine assembly 100, it is determined that the engine assembly 100 is in an engine warm-up phase. Then, the engine assembly 100 is operated in an engine warm-up mode in which the backflow F of fuel from the common-rail injector 106 is in heat exchange relationship with oil of the oil circuit 118 of the engine assembly 100. In a particular embodiment, it is determined that the engine assembly 100 is in a steady-state phase; and the engine assembly is operated in a steady-state mode in which the backflow F of fuel is directed toward the common-rail injector 106 without exchanging heat with the oil. In other words, the backflow F of fuel may be directed toward the common-rail injector 106 independently of the heat exchanger 120.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure, and such modifications are intended to fall within the appended claims.

1. A method of operating an engine assembly including an internal combustion engine, a common-rail injector for injecting fuel in a combustion chamber of the internal combustion engine, and an oil circuit for lubricating components of the engine assembly, the method comprising:
injecting fuel in the combustion chamber via the common-rail injector, the common-rail injector being in fluid flow communication with a source of fuel;
exchanging heat between a backflow of fuel from the common-rail injector with oil of an oil circuit of the engine assembly; and
flowing the backflow of fuel toward the common-rail injector while bypassing the source of fuel.

2. The method of claim 1, wherein injecting the fuel includes directing a portion of the injected fuel in the combustion chamber and directing a remainder of the injected fuel out of the injector and bypassing the combustion chamber, the backflow of fuel corresponding to the remainder of the injected fuel.

3. The method of claim 1, wherein exchanging heat between the backflow of fuel and the oil includes heating the oil by cooling the backflow of fuel.

4. The method of claim 1, wherein exchanging heat between the backflow of fuel and the oil includes cooling the oil by heating the backflow of fuel.

5. The method of claim 1, wherein exchanging heat between the backflow of fuel and the oil includes circulating the backflow of fuel in at least one first conduit of a heat exchanger and circulating the oil in at least one second conduit of the heat exchanger, the at least one first conduit in heat exchange relationship with the at least one second conduit.

6. The method of claim 1, further comprising mixing the backflow of fuel with a flow of fuel from the source of fuel before exchanging heat between the backflow of fuel and the oil.

7. The method of claim 1, wherein exchanging heat between the backflow of fuel and the oil is performed during a warm-up phase of the engine assembly, the method further comprising directing the backflow of fuel toward the common-rail injector without exchanging heat with the oil after completion of the warm-up phase.

8. The method of claim 7, wherein exchanging heat between the backflow of fuel and the oil is performed in a heat exchanger, directing the backflow toward the common-rail injector without exchanging heat with the oil includes directing the backflow in a bypass conduit having an first end upstream of the heat exchanger and second end downstream of the heat exchanger.

9. A method of operating an engine assembly including an internal combustion engine, a common-rail injector for injecting fuel in a combustion chamber of the internal combustion engine, and an oil circuit for lubricating components of the engine assembly, the method comprising:
determining that the engine assembly is in an engine warm-up phase; and
operating the engine assembly in an engine warm-up mode in which a backflow of fuel from the common-rail injector is in heat exchange relationship with oil of the oil circuit of the engine assembly.

10. The method of claim 9, further comprising:
determining that the engine assembly is in a steady-state phase; and
operating the engine assembly in a steady-state mode in which the backflow of fuel is directed toward the common-rail injector without exchanging heat with the oil.

11. An engine assembly, comprising:
an internal combustion engine having at least one combustion chamber;
at least one injector having an inlet fluidly connected to a source of fuel via a main conduit, a first outlet fluidly connected to the at least one combustion chamber, and a second outlet connected to the main conduit downstream of the source of fuel;
an oil circuit configured for circulating oil through components of the engine assembly; and
a heat exchanger having at least one first conduit and at least one second conduit in heat exchange relationship with the at least one first conduit, the second outlet of the at least one injector fluidly connected to the at least one first conduit, the oil circuit in fluid flow communication with the at least one second conduit of the heat exchanger.

12. The engine assembly of claim 11, wherein the second outlet of the at least one injector is fluidly connected to the inlet of the at least one injector via the at least one first conduit of the heat exchanger.

13. The engine assembly of claim 11, further comprising a connector having two inlets and one outlet, the outlet of the connector is fluidly connected to the inlet of the at least one injector, one of the two inlets fluidly connected to the second outlet of the at least one injector, the other of the two inlets fluidly connected to the source of fuel.

14. The engine assembly of claim 13, further comprising a pump, the pump having an inlet fluidly connected to the source of fuel and an outlet fluidly connected to the one of the two inlets of the connector.

15. The engine assembly of claim 11, wherein the main conduit is fluidly connected to the at least one first conduit of the heat exchanger, the engine assembly further comprising a bypass conduit having a first end and second end, the first end fluidly connected to the fuel supply conduit upstream of the heat exchanger, the second end fluidly connected to the fuel supply conduit downstream of the heat exchanger.

16. The engine assembly of claim 15, further comprising a bypass valve located on the bypass conduit between the first end and the second end, the bypass valve operable between a close configuration in which fluid communication between the first end and the second end is limited and an open configuration in which the first end is fluidly connected to the second end.
